(19) United States
(12) Patent Application Publication
(10) Pub. No.: US 2014/0365743 A1
(43) Pub. Date: Dec. 11, 2014

(54) Secure Erasure of Processing Devices

(71) Applicant: Seagate Technology LLC, Cupertino, CA (US)

(72) Inventors: Anthony John Pronozuk, Loveland, CO (US); Shawn Jacob Noland, Longmont, CO (US); James Edward Dykes, Longmont, CO (US); William Leon Rugg, Longmont, CO (US)

(73) Assignee: Seagate Technology LLC, Cupertino, CA (US)

(21) Appl. No.: 14/076,572

(22) Filed: Nov. 11, 2013

Related U.S. Application Data
(60) Provisional application No. 61/833,620, filed on Jun. 11, 2013.

(51) Int. Cl. G06F 12/08

(52) U.S. Cl. CPC G06F 12/0891
USPC 711/166

(57) ABSTRACT

Apparatus and method for performing secure erasure of a processing device, such as a data storage device in an object storage system. In accordance with some embodiments, an apparatus is provided with a plurality of processing devices arranged within an enclosed housing and each having an associated memory. A mechanical switch is coupled to the enclosed housing. The associated memories of the processing devices are securely erased responsive to activation of the mechanical switch.

### RELATED APPLICATION

This application makes a claim of domestic priority to copending U.S. Provisional Application No. 61/833,620 filed Jun. 11, 2013, the contents of which are incorporated by reference.

### SUMMARY

Various embodiments of the present disclosure are generally directed to the secure erasure of processing devices, such as data storage devices in distributed object storage system.

In accordance with some embodiments, an apparatus has a plurality of processing devices arranged within an enclosed housing with each having an associated memory. A mechanical switch coupled to the enclosed housing securely erases the associated memory of each of the processing devices responsive to activation of the mechanical switch.

In accordance with other embodiments, an apparatus has a plurality of data storage devices arranged within a housing each having a memory adapted to store data from a host device. A secure erasure hardware switch is connected to the housing and configured to be manually moved between an inactive position and an active position. The secure erasure hardware switch generates a secure erasure signal responsive to manual movement of the switch to the active position. A programmable processor is disposed within the housing and has associated programming stored in a processor memory to issue a secure erasure command to each of the plurality of data storage devices responsive to the secure erasure signal, each of the plurality of data storage devices securely erasing the associated memory thereof responsive to the secure erasure command.

In accordance with other embodiments, a method includes providing a storage enclosure having an enclosed housing, a processing device within the enclosed housing with an associated memory and a physical switch connected to an exterior of the enclosed housing. The physical switch is toggled from an inactive position to an active position to generate a secure erasure activation signal. The associated memory of the processing device is securely erased responsive to the secure erasure activation signal.

### BRIEF DESCRIPTION OF THE DRAWINGS

FIG. 1 is a functional representation of a storage rack which secures a number of storage enclosures in accordance with some embodiments.

FIG. 2 is a top plan representation of a selected storage enclosure from FIG. 1 in accordance with some embodiments.

FIG. 3 is functional block representation of a selected one of the data storage devices of FIG. 2.

FIG. 4 is a functional block diagram of the storage enclosure of FIGS. 1-2 and 7.

FIG. 5 illustrates functional operation of a hardware switch on the storage enclosure configured to initiate a secure erasure of data on the storage devices in the storage enclosure in accordance with some embodiments.

FIG. 6 illustrates the hardware switch of FIG. 5 in accordance with some embodiments.

FIG. 7 is functional representation of a secure erasure operation carried out using both hardware and software switching.

FIG. 8 illustrates a timer circuit used to validate the secure erasure signals of FIG. 7.

FIG. 9 is an example software architecture of the system of FIG. 1 configured to utilize the secure erasure operation of FIGS. 5-8.

FIG. 10 shows system services of the architecture of FIG. 9.

FIG. 11 is a flow chart for a SECURE ERASURE routine carried out in accordance with some embodiments.

### DETAILED DESCRIPTION

The present disclosure generally relates to secure erasure of data. Networked mass storage systems such as object storage systems often employ processing devices in the form of data storage devices which are operationally arranged to provide a relatively high data capacity memory storage space. The storage devices, also sometimes referred to as memory devices or processing devices, may be grouped together into storage enclosures that can be removably installed into a rack system (server cabinet).

Object storage systems are sometimes configured as cloud computing environments where data objects (e.g., files) from users (“account holders” or simply “accounts”) are replicated and stored in geographically distributed storage locations within the system. The network is often accessed through web-based tools such as web browsers, and provides services to a user as if such services were installed locally on the user's local computer.

Object storage systems are often configured to be massively scalable so that new storage nodes, servers, software modules, etc. can be added to the system to expand overall capabilities in a manner transparent to the user. A distributed object storage system can continuously carry out significant amounts of background overhead processing to store, replicate, migrate and rebalance the data objects stored within the system in an effort to ensure the data objects are available to the users at all times.

Data security can be an important consideration in operating mass storage systems. It may be desirable from time to time to subject a memory to a special data sanitizing operation to remove data from the memory. “Sanitizing,” or “secure erasure,” of a memory device generally refers to an operation whereby all traces of a data set in the device, including copies, prior revisions and in some cases associated metadata, are purged or otherwise altered so that the data essentially cannot be recovered from the memory device by an unauthorized third party.

A number of U.S. Federal and State Regulations require memory devices to be securely erased under certain circumstances. Failure to do so may result in civil and/or criminal penalty. Some well-known governmental standards that set forth various requirements for secure erasure include the NIST 800-88 Enhanced Secure Erase Standard and the DoD 5220 Block Erasure Standard. It can also he advisable to securely erase data in a memory device from time to time, such as to restore the device to an initial condition or prior to transfer of the memory to a third party.

Secure erasure can be destructive or non-destructive. Destructive secure erasure renders the devices unusable for subsequent storage of data. Non-destructive secure erasure substantially erases all traces of previously stored data, but leaves the memory device in an operable state to accommodate new data.

Some existing secure erasure techniques rely on an externally generated, host level command to initiate a data sanitizing operation. This presents a weakness in the data security scheme. For example, if an unscrupulous attacker is able to interrupt communications between a storage device and a host prior to the host being able to successfully transmit a data sanitization command, sensitive data may be easily recoverable from the storage device. Alternatively, an unscrupulous attacker may be able to maliciously initiate a secure erasure in order to wreak havoc within a memory system.

Accordingly, various embodiments of the present disclosure are generally to an apparatus and method for executing a secure erasure of data from data storage devices in a multi-device storage enclosure. As explained below, a storage enclosure is provided with a specially configured hardware (mechanical) switch that, when manually activated by a user, initiates a secure erasure operation for some or all of the storage devices within the storage enclosure. The hardware switch may be disposed between a locked door or other normally inaccessible location to prevent inadvertent secure erasure operations.

In some embodiments, a software switch is additionally activated as part of the secure erasure operation. Both hardware and software secure erasure signals may be required to authorize the secure erasure. Receipt of both erasure signals within a predetermined time interval may be required in order to authorize the secure erasure. Depending on the configuration, two users may be required to carry out the secure erasure using this scheme, with one user activating each switch. In this way, both inadvertent and maliciously enacted secure erasures can be substantially avoided.

In further embodiments, the storage enclosure provides storage at a storage node of an object storage system, such as but not limited to a cloud computing environment. The hardware switch can be operated in conjunction with system services to remove storage capacity from the system or reconfigure existing storage capacity in the system.

These and other features can be understood beginning with a review of FIG. 1 which generally depicts a mass storage system 100 in accordance with some embodiments. The system 100 includes a storage assembly 102 coupled to a computer 104 which in turn is connected to a network 106. The computer 104 can take a variety of forms such as a work station, a local personal computer, a server, etc. The computer 104 is not necessarily required as functionality provided thereby can be incorporated into the storage assembly 102. The storage assembly 102 includes a server cabinet (rack) 108 and a plurality of modular storage enclosures 110.

In some embodiments, the storage rack 108 is a 42 U server cabinet with 42 units (U) of storage, with each unit comprising about 1.75 inches (in) of height. The width and length dimensions of the cabinet can vary but common values may be on the order of about 24 in.×36 in. Other sizes can be used. Each storage enclosure can be a multiple of the storage units, such as 2 U, 3 U, etc. Fully populating the rack 108 with storage enclosures 110 can provide multiple Petabytes (10¹⁵ bytes) or more of storage for the computer 104 and/or network applications.

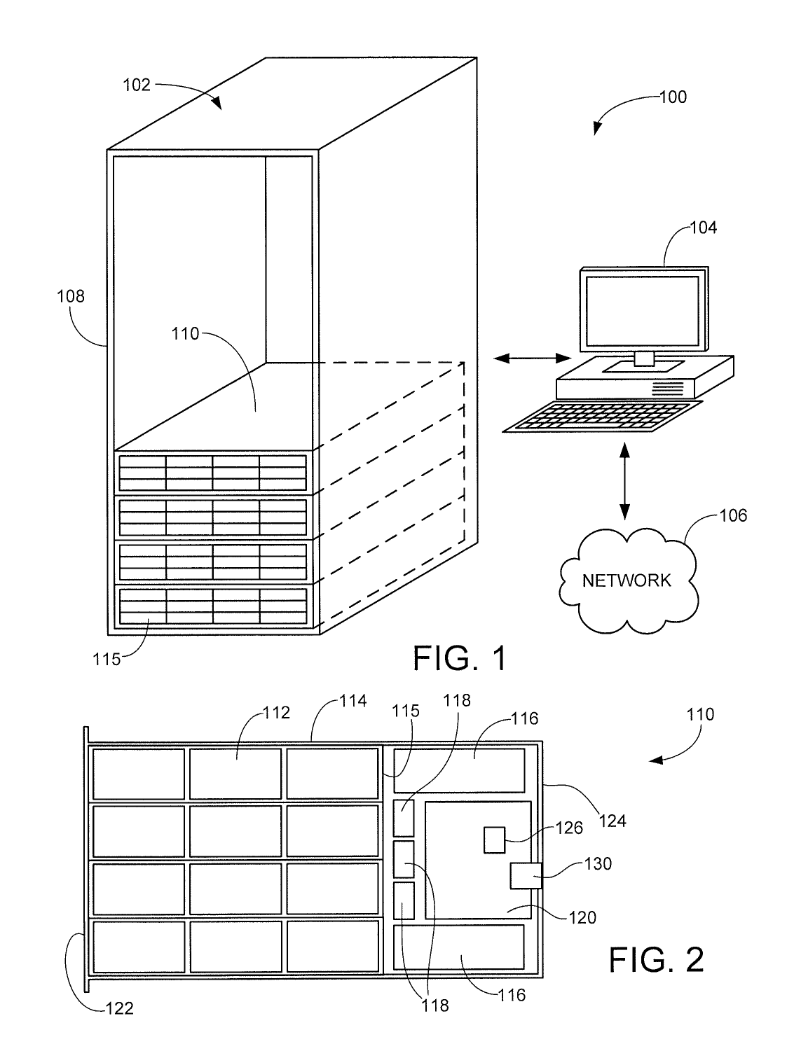

One example configuration for the storage enclosures 110 is shown in FIG. 2. Other arrangements can be used as desired. The configuration in FIG. 2 is a 36/3 U configuration with 36 (4×3×3) data storage devices 112 in a 3 U form factor height housing 114. A variety of other configurations can be used including storage enclosures with a total of N devices where N=12, 16, 20, 24, 30, 32, 48, etc. Sleds 115 can be used to secure multiple sets of the storage devices 112.

The storage enclosure 110 includes dual power supplies 116, multiple airflow fans 118 and at least one controller board 120. The power supplies 116 provide electrical power for the storage enclosures 110. The fans 118 draw airflow from openings (not separately shown) in a front facing side 122 of the housing 114 and pull the airflow through the housing and out openings (not shown) in a rear facing side 124 of the housing.

The controller 120 may have one or more intelligent processors 126 and can take a variety of configurations including but not limited to a server, a controller (including dual redundant RAID controllers), a cloud controller, dual port controllers, an Ethernet drive controller, etc.

Other support electronics and components can be provided in the storage enclosure 110 as well, including a boot storage memory device, wiring cables, switches, brackets, LED indicators, short-term emergency backup power supplies (e.g., batteries), motors, etc. A redundant design is provided so that substantially any failed component can be replaced while maintaining the device in an operational condition. Other relative placements of the various active elements within the storage enclosure 110 can be provided.

The storage enclosure 110 further includes a secure erasure switch assembly 130 which operates as discussed below to facilitate a secure erasure of the respective storage devices 112.

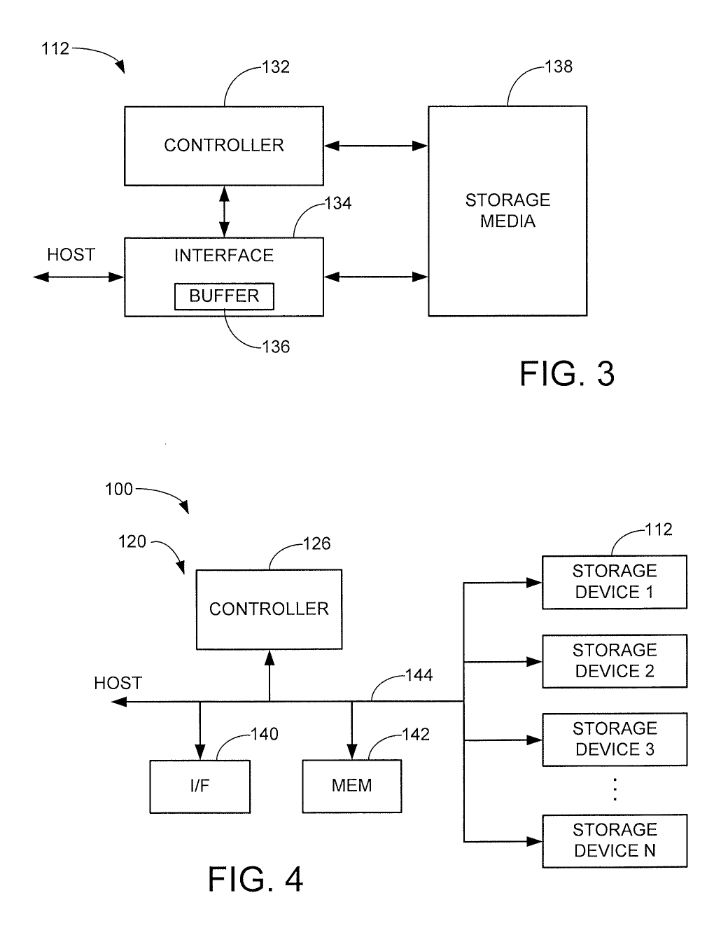

The storage devices 112 can take a variety of processing device configurations, such as but not limited to a hard disc drive (HDD), a solid state drive (SSD), a hybrid drive, etc. FIG. 3 is a functional block diagram for a generalized data storage device 112 in accordance with some embodiments. The data storage device 112 includes a programmable controller 132, an interface circuit 134 with a data buffer 136 and storage media 138. The controller 132 directs data transfers between the storage media 138 and a host device, such as the controller 104 in FIG. 1.

In the context of an HDD, the storage media 138 may take the form of one or more axially aligned magnetic recording discs which are rotated at high speed by a spindle motor. Data transducers can be arranged to be controllably moved and hydrodynamically supported adjacent recording surfaces of the storage disc(s). While not limiting, in some embodiments the storage devices 112 are 3½ inch form factor HDDs with nominal dimensions of 5.75 in×4 in×1 in.

In the context of an SSD, the storage media 138 may take the form of one or more flash memory arrays made up of non-volatile flash memory cells. Read/write/erase circuitry can be incorporated into the storage media module to effect data recording, read back and erasure operations. Other forms of solid state memory can be used in the storage media including magnetic random access memory (MRAM), resistive random access memory (RRAM), spin torque transfer random access memory (STRAM), phase change memory (PCM), in-place field programmable gate arrays (FPGAs), electrically erasable electrically programmable read only memories (EEPROMs), etc.

In the context of a hybrid device, the storage media 138 may take multiple forms such as one or more recording discs and one or more modules of solid state non-volatile memory (e.g., flash memory, etc.). Other configurations for the storage devices 112 are readily contemplated, including other forms of processing devices besides devices primarily characterized as data storage devices, such as computational devices, circuit cards, etc. that at least include computer memory to which secure erasure processing is applied.

FIG. 4 provides a functional block representation of the storage enclosure 110 of FIGS. 1-2 in accordance with some embodiments. Control modules on the control board 120 include the aforementioned controller 126 as well as an interface (I/F) circuit 140 and a local buffer memory (mem) 142. One or more bus structures 144 enable the passage of data and commands between the storage devices 112 (labeled 1 to N) and a host device, such as the local computer 104 in FIG. 1. While the secure erasure disclosed herein is applied to the storage devices 112, it can be applied to other aspects of the enclosure 110 as well including the memory 142.

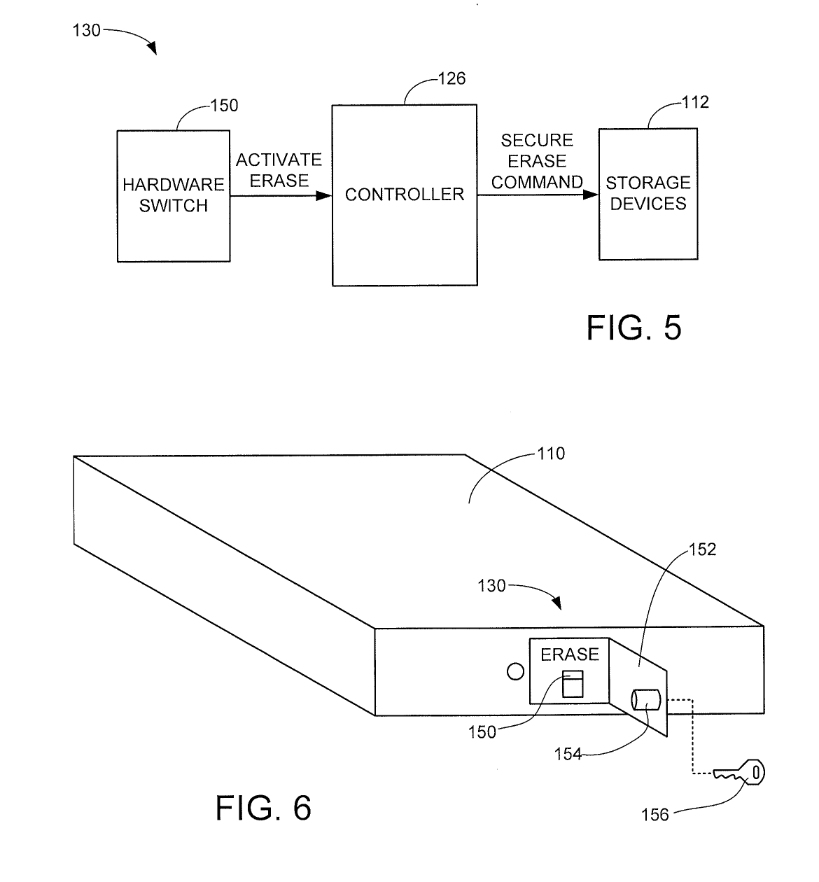

FIG. 5 shows the secure erasure switch assembly 130 from FIG. 2 to include a hardware switch 150. The hardware switch 150, also referred to as a mechanical switch or a physical switch, is configured to be manually operated by a user at such time that a secure erasure of the data in the storage devices 112 is desired. The switch 150 can take a variety of forms, such as a toggle switch that is normally in an inactive position. Mechanically transitioning (“flipping”) the switch 150 to an active position initiates the secure erasure process.

Moving the switch 150 to the active position provides an activate erase signal which is sensed by the controller 126. In response, the controller 126 forwards a secure erase command to each of the storage devices 112 to initiate secure erasure. As will be appreciated, each storage device 112 receiving the secure erase command will immediately initiate a secure erasure operation upon memory therein, such as the media 138 in FIG. 3. Other memory associated with the secure enclosure 110 can be subjected to the secure erase operation, such as the buffer memory 136 in FIG. 3, the storage enclosure buffer memory 142 in FIG. 4, etc.

The secure erasure can be carried out in a variety of ways. For example and not by way of limitation, in an HDD environment random and/or predetermined data patterns may be written, erased and rewritten a number of times to all of the data tracks on the rotatable storage discs in order to mask the previously recorded data. In other embodiments, a direct current (DC) erase can be carried out multiple times so that all of the magnetization directions of the recording structures of the media are set to a selected domain direction.

In an SSD environment, multiple write and erasure cycles can be applied to the flash memory array to similarly mask the previously written data. Random patterns can be written, or all of the memory cells can be written to a common value (e.g., maximum accumulated charge, etc.) prior to an erase operation to remove the accumulated charge.

Other methodologies can be applied as desired. It is contemplated that the secure erasure process will be non-destructive so that the memory is erased but otherwise serviceable for the subsequent storage of data. In other embodiments, however, the secure erasure process can be configured to be destructive through the application of overvoltage or other conditions that result in the media 138 being in a state incapable of subsequently storing data.

To reduce the likelihood of an inadvertent secure erasure operation, as depicted in FIG. 6 the secure erasure hardware switch 150 may be located in a normally inaccessible location, such as behind a door 152 or other covering member which may be secured via a lock 154 and key 156. Other locations and configurations for the hardware switch 150 can be used. It is contemplated that the hardware switch 150 will be incorporated into or otherwise physically proximate and coupled to the storage enclosure 110.

A feature of this arrangement is an assurance that the secure erasure will actually be carried out in the storage enclosure 110 that is coupled to the switch 150, and not inadvertently in some other enclosure. Another feature of this arrangement is that remote attackers will not be able to initiate, via network access, a malicious secure erasure operation without physical access to the actual storage enclosure. For example, the storage enclosure 110 can be specifically configured such that a secure erase command cannot be issued to the storage devices without physical activation of the hardware switch, or receipt of such a command is not executed unless the switch 150 has also been set to the secure erasure position. The switch 150 thus provides a physical lockout of the secure erasure process.

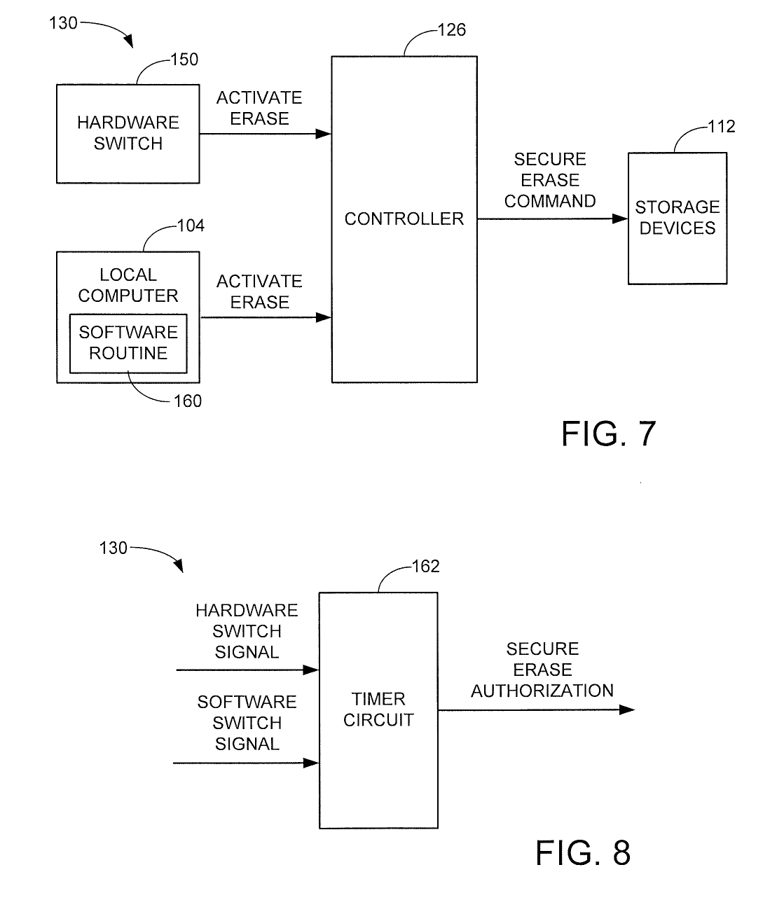

FIG. 7 illustrates an embodiment for the storage enclosure 110 in which both hardware and software switches are used to initiate the secure erasure process. The hardware switch 150 provides an activate erase signal to the controller 126 responsive to the movement of the switch 150 to the active (secure erase) position. In addition, a software routine 160 in a host device, such as the local computer 104 in FIG. 1, provides a second activate erase signal to the controller 126. The software routine 160 operates as a software switch to further initiate the secure erase operation.

The software routine 160 can be configured as an application, utility or other program stored in a physical memory location and executable by the a programmable processor of the local computer 104. The routine 160 can require the entry of a password or other security feature to prevent unauthorized access. In some embodiments, a user accesses the local computer (host device) 104 through a graphical user interface (GUI) such as a screen monitor, keypad, mouse, touch screen, voice recognition interface, biometric security system, etc. and is given an option whether to initiate a secure erase for one or more selected storage enclosures 110. In systems that employ multiple storage enclosures (see e.g., FIG. 1), each storage enclosure may have a separate address or other identifier that is displayed for selection by the user. The user may select all or a portion of the storage enclosures 110 coupled to the local computer 104 for secure erase processing. By entering an appropriate input, the local computer 104 transmits the activate erase signal to the controller 126.

The controller 126, in response to both the first (hardware) and second (software) activate erase signals, forwards a secure erase command to the storage devices 112, as shown in FIG. 7. While it is contemplated that all of the storage devices 112 in the selected enclosure(s) 110 will be selected, in other embodiments the software routine may include the option of designating individual devices less than all of the devices in the storage enclosure (or other memories within the enclosures). In such case, the controller 126 will issue secure erase commands to only those devices/memories within the storage enclosure 110 that were identified by the user via the software routine. In this way, the hardware switch 150 may designate a first set of the memory devices 112 and the software switch (routine 160) may designate a smaller, second set of memory devices constituting a subset of the first set of memory devices.

A request for secure erasure may be made at the data level so that certain blocks of data less than the entire storage capacity of one or more of the data storage devices 112 are requested to be securely erased. In such cases, commands will be issued to securely erase only those portions of memory in which the data are stored. The data may be identified at the host level via logical addressing (e.g., logical block addresses, LBAs), so that a translation from logical address to physical address is carried out to identify the locations of the associated data. Secure erasure commands can be given at other levels as well, such as for specific data objects, files, etc. Secure erasure is thereafter carried out at those locations storing the respective data sets.

In some embodiments, receipt of both the first and second activate erase signals during ongoing operation will be sufficient to initiate the secure erasure process. Alternatively, a suitable time-interval may be specified during which the receipt of both signals is required prior to authorization of the secure erase process. As depicted in FIG. 8, a timer circuit 162 can be incorporated into the secure erasure switch assembly 130. The timer circuit 162 initiates an elapsed time interval upon receipt of one of the activate erase signals. The time interval can be any suitable period. Receipt of either signal can initiate the interval, or the interval can commence upon receipt of a selected one of the signals.

It is contemplated that the software signal may be required to be received first followed by the hardware signal, but this is not necessarily required, as the order may be reversed or the order may not matter. The time interval can be set to a relatively short elapsed time period such as on the order of less than 10 seconds. In some cases, the time interval may be set to a value of about 7 seconds. In other cases, the time interval may be set to a value of about 4 seconds. The time interval may be adjustable using the software routine 160.

If both activate erase signals are received within the time interval, the timer circuit 162 provides a secure erase authorization signal to the controller 126, and the controller proceeds to command the secure erasure operation. If one activate erase signal is received but the other is not within the elapsed time interval, the secure erasure operation is aborted; that is, the interval “times out” and no authorization is granted.

Features of this approach include the fact that a secure erasure operation will not occur if the hardware switch is activated by itself, and a secure erasure operation will not occur if the software switch is activated by itself. In some cases, the time interval and relative locations of the storage enclosure 110 and the host computer 104 can be arranged such that two users are required in order to execute the secure erasure (one activating the software routine, the other activating the hardware switch). That is, physical locations or other impediments can be provided so that it is essentially impossible for one individual to activate both switches within the allotted time frame. This provides an additional measure of assurance that an inadvertent and/or malicious secure erasure is not enacted.

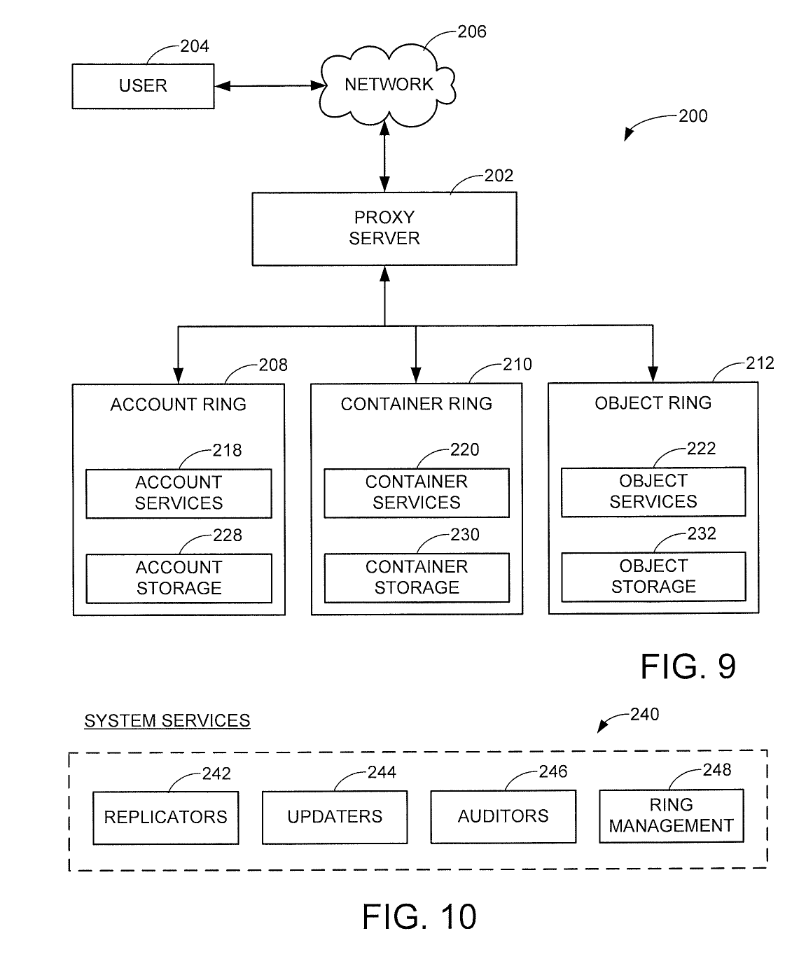

The secure erasure switch assembly 130 can be readily incorporated into the software architecture of an object storage system 200, as represented in FIG. 9. The architecture of FIG. 9 generally describes a cloud computing environment, but this is merely illustrative and is not limiting. A proxy server 202 may be formed from the one or more management servers and operates to handle overall communications with users 204 of the system 100 via a network 206. The network 206 can take a variety of forms such as the Internet.

The proxy server 202 accesses a plurality of map structures, or rings, to control data flow to the respective data storage devices 112 (FIG. 3). The map (ring) structures include an account ring 208, a container ring 210 and an object ring 212. Other forms of rings can be incorporated into the system as desired. Generally, each ring is a data structure that maps different types of entities to locations of physical storage. Each ring generally takes the same overall format, but incorporates different hierarchies of data. The rings may be stored in computer memory and accessed by an associated processor during operation.

The account ring 208 provides lists of containers, or groups of data objects owned by a particular user (“account”). The container ring 210 provides lists of data objects in each container, and the object ring 212 provides lists of data objects mapped to their particular storage locations.

Each ring 208, 210, 212 has an associated set of services 218, 220, 222 and storage pools 228, 230, 232. The services and storage enable the respective rings to maintain mapping using zones, devices, partitions and replicas. The services may be realized by software, hardware and/or firmware. In some cases, the services are software modules representing programming executed by an associated processor of the system.

A zone is a physical set of storage isolated to some degree from other zones with regard to disruptive events. A given pair of zones can be physically proximate one another, provided that the zones are configured to have different power circuit inputs, uninterruptable power supplies, or other isolation mechanisms to enhance survivability of one zone if a disruptive event affects the other zone. Alternatively, a given pair of zones can be geographically separated so as to be located in different facilities, different cities, different states and/or different countries.

Devices refer to the physical devices in each zone. Partitions represent a complete set of data (e.g., data objects, account databases and container databases) and serve as an intermediate “bucket” that facilitates management locations of the data objects within the cluster. Data may be replicated at the partition level so that each partition is stored three times, one in each zone. The rings further determine which devices are used to service a particular data access operation and which devices should be used in failure handoff scenarios.

In at least some cases, the object services block 222 can include an object server arranged as a relatively straightforward blob server configured to store, retrieve and delete objects stored on local storage devices. The objects are stored as binary files on an associated file system. Metadata may be stored as file extended attributes (xattrs). Each object is stored using a path derived from a hash of the object name and an operational timestamp. Last written data always “wins” in a conflict and helps to ensure that the latest object version is returned responsive to a user or system request. Deleted objects are treated as a 0 byte file ending with the extension “.ts” for “tombstone.” This helps to ensure that deleted files are replicated correctly and older versions do not inadvertently reappear in a failure scenario.

The container services block 220 can include a container server which processes listings of objects in respective containers without regard to the physical locations of such objects. The listings may be as SQLite database files or some other form, and are replicated across a cluster similar to the manner in which objects are replicated. The container server may also track statistics with regard to the total number of objects and total storage usage for each container.

The account services block 218 may incorporate an account server that functions in a manner similar to the container server, except that the account server maintains listings of containers rather than objects. To access a particular data object, the account ring 208 is consulted to identify the associated container(s) for the account, the container ring 210 is consulted to identify the associated data object(s), and the object ring 212 is consulted to locate the various copies in physical storage. Commands are thereafter issued to the appropriate storage controller (e.g., computer 104 in FIG. 1) to retrieve the requested data objects from the associated data storage devices (e.g., devices 112 in FIGS. 2-3).

Additional services 240 of the system 200 are represented in FIG. 10. The services 240 may be incorporated by or used in conjunction with the account, container and ring services 218, 220, 222 represented in FIG. 9. The services 240 in FIG. 10 may be realized as software, hardware and/or firmware. In some cases, the services represent programming steps stored in memory and executed by one or more programmable processors of the system.

The system services 240 can include include replicators 242, updaters 244, auditors 246 and a ring management module 248. Generally, the replicators 242 attempt to maintain the system in a consistent state by comparing local data with each remote copy to ensure all are at the latest version. Object replication can use a hash list to quickly compare subsections of each partition, and container and account replication can use a combination of hashes and shared high water marks.

The updaters 244 attempt to correct out of sync issues due to failure conditions or periods of high loading when updates cannot be timely serviced. The auditors 246 crawl the local system checking the integrity of objects, containers and accounts. If an error is detected with a particular entity, the entity is quarantined and other services are called to rectify the situation.

The ring management module 248 operates to process updates associated with the map (ring) structures. This can include rebalancing (e.g., data migrations), the addition of new storage to the system 200, the removal or reconfiguring of existing storage from the system 200, etc.

In the context of a larger distributed object storage system as depicted in FIGS. 9-10, from time to time it may become desirable to execute secure erasure of various storage devices 112 utilized to store data objects and other entities of the system. In some cases, system parameters obtained from various services, controllers, servers, etc. may signify a need to decommission certain data storage devices 112 to remove the devices from service. In such case, new mapping would be generated by the ring management module 248 and the existing data on the affected devices would be migrated to new locations, after which a secure erasure operation may be carried out upon the devices using the secure erasure switch assembly 130 as discussed above.

In other embodiments, secure erasure may be carried out using a secure erasure software switch managed at the services level. For example and not by way of limitation, the foregoing data migration and rebalancing of the rings may take place to place one or more data storage devices 112 into a condition where the devices may be removed from service. The data formerly stored on the devices may be relocated to new devices in a different zone. Thereafter, system administrative personnel may activate the hardware switch(es) 150 on the affected storage enclosure(s) 110. A software switch signal from the ring management module 248, or other aspect of the system 200, may additionally be required and forwarded to the associated storage enclosure, by way of the local storage controller, to authorize the secure erasure of the storage media 138 of the affected storage devices.

If secure erasure capabilities are incorporated into the system architecture such as, for example, in the ring management module 248, the ring management module or other services (e.g., the host computer in this case) may forward a secure erasure signal to one or more local storage nodes (e.g., storage controllers, storage enclosures, etc.). However, such secure erasure will not be carried out until and unless the associated hardware switch(es) 150 at the local storage node(s) is/are physically moved to the active position. In this way, malicious parties or inadvertent code operations will not undesirably securely erase existing data objects and other data structures from the system.

Similarly, the activation of a hardware switch 130 by a local user or administrator will not result in the erasure of any data from the system until or unless an authorization signal is forwarded from a remote location, such as from the ring management module 248 or other system services.

It is contemplated that the environment of FIGS. 9-10 will be subjected to the replacement, removal and/or refurbishment of existing storage on a regular basis. The secure erasure switch assembly 130 provides an effective way to ensure that such operations are carried out under the authorization of local administrative personnel and under the authorization of the associated mechanisms in the system.

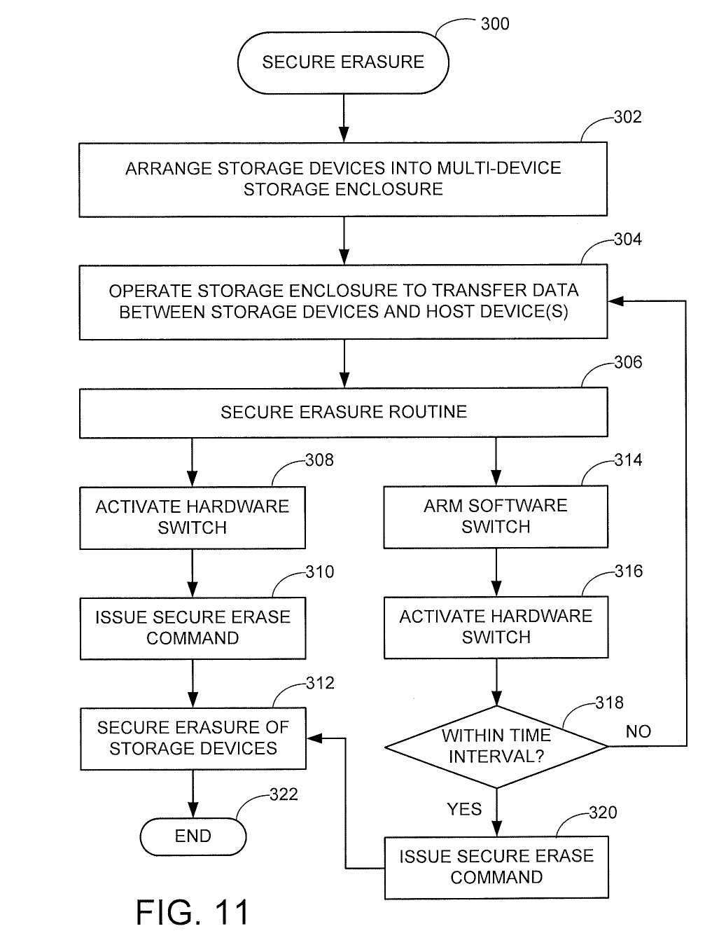

FIG. 11 provides a SECURE ERASURE routine 300 in accordance with the foregoing discussion. The flowchart is merely exemplary and is not limiting, and various steps may be added, modified and/or omitted as required. For purposes of discussion, the routine 300 will be discussed in terms of the object storage system 200 of FIG. 9 using storage nodes made up of multiple storage assemblies 102 with storage enclosures 110 as represented in FIGS. 1-2.

At step 302, storage devices such as 112 are initially arranged into one or more multi-device storage enclosures such as 110, and the storage enclosures may be installed into storage cabinets coupled to a host computer such as 104 which may be configured as a storage controller for one or more storage nodes.

Each storage enclosure 110 is operated at step 304 to transfer data between the storage devices 112 and one or more host devices, such as the proxy server 202 depicted in

FIG. 9. As discussed above, the storage enclosure 110 can be used to provide local and network memory storage in any number of operational environments including cloud storage, RAID storage, etc.

At some point after extended operation of the storage enclosure, a decision is made to perform a secure erasure of the storage devices 112 in the storage enclosure. As discussed above, such decision can arise under a variety of operational environments and conditions, including at a ring management services, local storage controller, or other service level.

The decision to execute the secure erasure may be made by the owners of the data (e.g., a remote party) or may be made by the owners/operators of the system 200. For example, a user 204 (FIG. 9) may issue a request that certain data be securely erased, and the local operator will identify which storage enclosure or enclosures have copies of the associated data. Depending on the scope, individual devices and individual blocks of memory within such devices may be further identified.

Alternatively, the local operator may decide to apply a secure erasure of one or more storage enclosures in order to decommission and transfer/discard the storage enclosures, or to restore the storage enclosures to an initial, erased condition ready to receive new data objects and/or other data sets.

Regardless, for purposes of the present discussion it will be contemplated that the decision to proceed with the secure erasure process is an authorized decision rather than a malicious or inadvertent action.

Once the secure erasure decision has been made, a number of alternative paths may be taken including a hardware solution and a combined hardware/software solution. The hardware solution proceeds at step 308 where the hardware switch 150 for the affected storage enclosure 110 is activated, as discussed above. This causes the storage enclosure controller 126 to issue a secure erase command at step 310, and the data storage devices 112 execute a secure erasure operation at step 312.

The combined hardware/software solution proceeds at step 314 to activate (arm) the software switch via the software routine 210. The hardware switch 150 associated with the storage enclosure 110 is activated at step 316. When a timer such as 162 is used, decision step 318 determines whether both activation signals were received within the predetermined time interval. If not, the secure erasure operation is aborted and the routine returns to step 304.

If the activation signals were received within the allotted time frame, the controller 126 proceeds to issue the secure erase command and the devices 112 perform the secure erasure at step 312, as before. The process is then shown to end at step 322, although other steps may be carried out at this time as well including removal of the storage enclosure 110 from the rack 102 (FIG. 1), etc. It will be appreciated that the combined hardware/software solution depicted in FIG. 11 can take other forms and sequences, such as activation of the hardware switch first, followed by generation of the software authorization signal, etc.

It will now be appreciated that the secure erasure switch assembly 130 as variously embodied herein supports a modular device arrangement for the respective storage enclosures 110. Hardware switches such as 150 to enact secure erasure operations can substantially eliminate the ability of remote malicious parties and inadvertent local users from carrying out undesired secure erasures. Because the exemplary hardware switches 150 are incorporated in or otherwise physically associated with the respective enclosures 110, this helps ensure that the correct data storage devices and/or other memories are the ones being securely erased. The use of a software switch can add further security to the system, including the use of a time interval to require multiple operators to carry out the secure erase.

While data storage devices such as HDDs, SSDs and hybrid drives have been exemplified as different types of processing devices to which the secure erasure operation can be applied, such is merely exemplary and is not limiting. Any number of different types of processing devices having a memory can be subjected to the secure erasure operations disclosed herein.

For purposes of the present disclosure, the term “secure erasure hardware switch” and the like will be understood to be a specially configured hardware switch moveable between an inactive position and an active position during operation of the associated storage enclosure or other device, and will not constitute a power on/off switch or other switch that, when activated, places the storage enclosure or other device in an operational state.

It is to be understood that even though numerous characteristics and advantages of various embodiments of the present disclosure have been set forth in the foregoing description, together with details of the structure and function of various embodiments thereof, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An apparatus comprising:
a plurality of processing devices arranged within an enclosed housing each comprising an associated memory; and
a mechanical switch coupled to the enclosed housing that securely erases the associated memory of each of the processing devices responsive to activation of the mechanical switch.

2. The apparatus of claim 1, wherein the switch is moveable between an active position and an inactive position, wherein movement of the switch to the active position generates an internal secure erasure activation signal, and wherein each of the processing devices securely erase the associated memories responsive to the secure erasure activation signal.

3. The apparatus of claim 1, wherein the processing devices each comprise a data storage device to store data objects in a storage node of an object storage system having a server which communicates with the storage node via network, wherein the associated memories of the data storage devices are securely erased responsive to both the activation of the switch and a receipt of an external secure erasure activation signal from the server within a predetermined time interval.

4. The apparatus of claim 1, wherein the processing devices each comprise a data storage device to store data objects in a storage node of an object storage system having an associated storage controller which communicates with a remote server via a network, wherein the associated memories of the data storage devices are securely erased responsive to both the activation of the switch and a receipt of an external secure erasure activation signal from the storage controller within a predetermined time interval.

5. The apparatus of claim 1, wherein the enclosed housing comprises a cover panel and the switch is located behind the cover panel within an interior of the enclosed housing, wherein the switch is activated by a user opening the cover panel and mechanically advancing the switch from a first position to a second position.

6. The apparatus of claim 5, further comprising a lock and key arrangement connected to the cover panel, wherein the user uses the key to unlock the lock and key arrangement to open the cover panel and access the switch.

7. The apparatus of claim 1, wherein the switch is characterized as a hardware switch which generates a first secure erasure activation signal responsive to movement of the switch from an inactive position to an active position, and wherein the apparatus further comprises a controller adapted to execute a software routine in a controller memory to activate a software switch responsive to a user input, wherein activation of the software switch generates a second secure activation signal to initiate the secure erasure of data in the associated memories of the processing devices.

8. The apparatus of claim 7, wherein a control circuit forwards a secure erasure command to the processing devices responsive to receipt of both the first and second secure erasure activation signals.

9. The apparatus of claim 8, wherein the control circuit comprises a timer which initiates a predetermined time interval responsive to receipt of a selected one of the first or second secure erasure activation signals, wherein the control circuit generates the secure erasure command responsive to receipt of the remaining one of the first or second erasure activation signals prior to a conclusion of the predetermined time interval, and wherein the control circuit does not generate the secure erasure command responsive to the control circuit not receiving the remaining one of the first or second erasure activation signals prior to the conclusion of the predetermined time interval.

10. The apparatus of claim 1, wherein the processing devices perform multiple data overwrite operations upon the associated memories to securely erase data stored therein.

11. The apparatus of claim 1, wherein the plurality of processing devices is a first group of processing devices within the enclosed housing, wherein the apparatus further comprises:
a second group of processing devices within the enclosed housing having associated memory;
a software switch module configured to generate a software secure erasure activation signal that selectively identifies the first group of processing devices for erasure; and
a control circuit which, responsive to activation of the mechanical switch and the software secure erasure activation signal, securely erases the first group of processing devices without securely erasing the second group of processing devices.

12. The apparatus of claim 1, wherein the processing devices perform a non-destructive secure erasure of the associated memories responsive to user activation of the hardware switch so that, at the conclusion of the non-destructive secure erasure, the memories remain usable for storage of subsequently presented data.

13. The apparatus of claim 1, wherein the processing devices perform a destructive secure erasure of the associated memories responsive to user activation of the hardware switch so that, at the conclusion of the destructive secure erasure, the memories are physically damaged so as to be unable to store subsequent data.

14. An apparatus comprising:
a plurality of data storage devices arranged within a housing each having a memory adapted to store data from a host device;
a secure erasure hardware switch connected to the housing and configured to be manually moved between an inactive position and an active position, the secure erasure hardware switch generating a secure erasure signal responsive to manual movement of the switch to the active position; and
a programmable processor disposed within the housing and having associated programming stored in a processor memory to issue a secure erasure command to each of the plurality of data storage devices responsive to the secure erasure signal, each of the plurality of data storage devices securely easing the associated memory thereof responsive to the secure erasure command.

15. The apparatus of claim 14, wherein the programmable processor is characterized as a storage enclosure processor, and the apparatus further comprises a host programmable processor and a memory which stores associated programming used by the host programmable processor to generate and transfer a software switch secure erasure signal to the storage processor, and wherein the storage enclosure processor further issues the secure erasure command to each of the plurality of data storage devices responsive to receipt of the software switch secure erasure signal.

16. The apparatus of claim 14, further comprising a secure erasure software switch comprising a software routine stored in a controller memory and executed by a controller to generate a second secure erasure signal, wherein the programmable processor issues the secure erasure command responsive to receipt of both the secure erasure signal and the second secure erasure signal within a predetermined time interval.

17. A computer implemented method comprising:
providing a storage enclosure comprising an enclosed housing, a processing device within the enclosed housing having an associated memory and a physical switch connected to an exterior of the enclosed housing;
toggling the physical switch from an inactive position to an active position to generate a secure erasure activation signal; and
securely erasing the associated memory of the processing device responsive to the secure erasure activation signal.

18. The method of claim 17, wherein the secure erasure activation signal is a hardware switch activation signal, and wherein the method further comprises generating a software switch activation signal using a software routine stored in a processor memory and executed by a programmable processor, wherein the secure erase command is further generated responsive to receipt of both the hardware switch activation signal and the software switch activation signal within a predetermined time interval.

19. The method of claim 17, further comprising removing the storage enclosure from a storage cabinet, and installing a new, replacement storage enclosure in the storage cabinet.

20. The method of claim 17, wherein the storage enclosure comprises a plurality of data storage devices each having associated memory arranged to store user data objects in an object storage system, wherein respective secure erasure commands are forwarded to each of the plurality of data storage devices responsive to the secure erasure activation signal, and wherein each of the associated memory of the plurality of data storage devices is securely erased responsive to the secure erasure commands.
